(19) United States
(12) Patent Application Publication
(10) Pub. No.: US 2010/0169455 A1
(43) Pub. Date: Jul. 1, 2010

(54) Embedded Persistent Message Management

(76) Inventor: Robert Stetson Gorham, Champaign, IL (US)

Correspondence Address: ROBERT STETSON GORHAM, JR., 1002 WEST HEALEY STREET, CHAMPAIGN, IL, 61821, US

(21) Appl. No.: 12/345,508

(22) Filed: Dec. 29, 2008

(51) Int. Cl. G06F 15/16; G06F 17/00

(52) U.S. Cl. 709/218; 715/205

(57) ABSTRACT

A system for distributed message management in an Ad Hoc, viral environment, in which noteworthy or interesting digital content may be passed on to sets of friends or associates and re-deployed further and further outward, yet maintaining an ability to tie the media to the message via a hard coded set of hot-links to a Persistent Web-based Media Server, from which the messages can be monitored, altered, and used to capture a wide network of individuals who may have found the media valuable, interesting or fun.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Technical Field

This invention relates to the World Wide Web, and more particularly, to a method and system for linking advertising or informational messages to digital content which might be distributed Ad Hoc or virally throughout the Internet.

2. Problem Definition

There are a number of different ways digital messages or digital content can be dispersed. If content is embedded in hosted web sites, Internet search engines can catalog and present relevant web pages. Direct subscription networks, and e-mail can be used to distribute information or present relevant web sites and information. Digital content can also be distributed on CDs, DVDs, flash disks, thumb drives and other emerging technologies. Such tools may distribute content self contained, “intact”, or they may also distribute URL links to data which is hosted elsewhere.

Content can be formally “published” and distributed. However, it is often “Virally” distributed—that is forwarded “intact”, informally from friend to friend, or colleague to colleague. In such a transmission the content may be transferred without any means to track or alter embedded messages.

As information is distributed, the link between the content developer and the dispersed content can be blurred. Embedded URL links can be broken as developer servers are modified and relevant addresses changed.

The objective of this invention was to create a methodology which encourages nontraditional as well as traditional data dispersal, but maintains persistent and manageable communications linkage. Such linkage is intended to support advertising or the establishment and support of Ad Hoc communities. Such communities might form to critique a project, vote for improvements, assemble clues in an actual on-going criminal case or interact to engage in a widely-dispersed digital game.

3. Fields of Search

345/419 Three-dimension modeling; 382/282 Selecting a portion of an image; 709/245 Computer-to-computer data addressing; 705/14 Distribution or redemption of coupon or incentive or promotion program; 705/27 Electronic catalog; 709/200 Miscellaneous; 709/203 Client Server; 709/217 Remote data accessing; 709/219 Accessing a remote server; 709/229 Network resources access controlling; 715/700 Operator interface (e.g. Graphical User Interface); 715/713 Display processing; 715/825 Dynamically generated menu items; 715/838 Thumbnail or scaled icon image; 715/839 Icons imitating real life object; 715/840 Using button array; 715/853 Network structure; 715/854 Navigation within structure; 715/855 On-screen roadmap or index

4. Information Disclosure Statement of Persistent Message Management by Robert Stetson Gorham

Pursuant to the guidelines for Information Disclosure Statements set forth in 37 C.F.R. Sections 1.97-1.99 and MPEP Section 609, Applicant submits herewith patents, publications or other information of which is believed to be material to the examination of this application and in respect of which there may be a duty of disclosure in accordance with 37 CFR 1.56. A list of patents is set forth herewith:

U.S. Pat. No. 7,319,975 Jan. 15, 2008 Internet-based advertising and referral system Monteverde An Internet-based referral tracking and compensation system. The system includes a number of advertisers' web sites and an advertiser associate site which displays a series of selectable links (hyper-links), on a user's computer. The system can transmit the selected web site to an internet user's computer where the user can interact with the selected sponsor's web site. The invention claims methods for web site owners to become an advertising associate's web site. It also describes methods by which advertisers are offered varying positions of display placement on an advertiser associates web site based on bid fees or payments for referrals. The referral system also can assign an advertiser associate identifier to establish that a referral occurred which can be tracked, ultimately resulting in compensation paid to the advertiser associate web site owner.

U.S. Pat. No. 7,219,162 May 15, 2007 System and method for accessing content of a web page Donker, et al. A system for searching, storing, evaluating and ranking alternative web sites. It also includes a method for manually selecting alternative web sites for viewing web pages on the client computer. It also permits dynamic selection of a best performing web page. The system uses hyper-links to specific URLs to establish locations of web page variants.

U.S. Pat. No. 7,209,602 Apr. 24, 2007 Method for providing real-time service of huge and high quality digital image on internet Kim A method of establishing layers of information of an image which may include image, magnification or reduction as access to additional data cells depending on the position of a view pointer on a display within a client system, being delivered from a data set from a server system. The system is focused on delivering compressed or expanded data sets based on the level of image compression desired.

U.S. Pat. No. 6,907,563 Jun. 14, 2005 System and method for composing heterogeneous media components into a unified environment for rich spatio-temporal hotlink authoring and action enablement in low-bandwidth presentations Kumar, et al. The system go separates media into tracks and components and evaluates client viewer capabilities and manages data distribution appropriate for use on the client display. Overlapping hot-links are used to change presentation state, position or content.

U.S. Pat. No. 6,892,354 May 10, 2005 Method of advertising on line during a communication link idle time Servan-Schreiber, et al. Method of advertising on-line during a communication link idle time.

U.S. Pat. No. 6,856,331 Feb. 15, 2005 System and method of enriching non-linkable media representations in a network by enabling an overlying hotlink canvas Chang, et al. Techniques for enriching a non-linkable media representation and making it hot-linkable at a user terminal.

U.S. Pat. No. 6,360,221 Mar. 19, 2002 Method and apparatus for the production, delivery, and receipt of enhanced e-mail Gough, et al. A method for providing e-mail which may include messages with a self-executing programmable enhancement such as a link to an advertising web site which may include advertising banners and buttons providing hyperlinks to additional advertiser's web sites.

U.S. Pat. No. 6,301,447 Oct. 9, 2001 Method and system for creation and interactive viewing of totally immersive stereoscopic images Jackson, et al. This is one in a series of patents which describe methods for creating digital images which can be viewed on computers and create “Virtual” images and “Virtual” Tours. This invention does not deal with displaying or actually printing images created.

U.S. Pat. No. 6,230,167 May 8, 2001 Method and apparatus for generating and displaying hotlinks in a panoramic three dimensional scene Lipscomb, et al. A method which facilitates adding hotlinks inside a panoramic scene. The hotlink areas are displayed by identifying the at least one element of the second environment map, modifying the color value of the elements of the first environment that correspond to the at least one element of the second environment, thereby producing a modified environment map which is then rendered for display.

U.S. Pat. No. 6,182,133 Jan. 30, 2001 Method and apparatus for display of information prefetching and cache status having variable visual indication based on a Period of time since prefetching Horvitz An apparatus and accompanying methods for prefetching, e.g., web pages into local cache of a client computer. As the browser prefetches and stores each web page (or component thereof) in its local cache, the browser provides a suitable and preferably visual indication, through its graphical user interface, to a user that this item has been fetched and stored.

U.S. Pat. No. 6,009,410 Dec. 28, 1999 Method and system for presenting customized advertising to a user on the world wide web LeMole, et al. The Customized Advertising Repository (CAR) server which can be accessed by a registered user through his or her browser either by clicking on an icon, or by inputting the specific URL address of the particular server which stores that user's advertising repository. That customized ad repository is processed and configured by the Customized Advertising Repository (CAR) server for that particular user based on that user's previously provided user profile. Such personalized information can configure advertising expected to appeal to the viewer. From such dynamically configured composite page or pages, the user can then click on a particular image, video window, banner, etc., to retrieve, through a hyperlink, further information directly from the selected advertiser's own Web site or mirror Web site.

U.S. Pat. No. 5,708,764 Jan. 13, 1998 Hotlinks between an annotation window and graphics window for interactive 3D graphics Borrel, et al. Embedded in annotation text is a command or hotlink for controlling operation of a graphics processing engine. In response to user selection of a hotlink command, the controller performs a function associated with three-dimensional objects, a three-dimensional markup, a predefined view point, or a predefined animation.

### SUMMARY OF THE INVENTION

The World Wide Web is a gateway for accessing sources of information, entertainment, and interactive content. Some content resides on statically hosted servers. Other content can be sent fully intact from user to user.

Creating World Wide Web content may require significant resources and effort. Its value can be underwritten with advertising and sponsorship. Conversely, the content might be of such an interesting nature, it could entice visitors to read and interact with associated advertising messages.

In static hosting situations, sponsors often advertise in sets of fixed or alternating “Banner” headlines or embedded placement spaces within the hosting web site. These advertisements can be altered on the hosting site.

An initial viewer can certainly alert a friend about interesting content by forwarding host address data to his or her friends. In that case, the second and third stage viewers would see the digital content in place with the same surrounding advertisements as long as the viewers are accessing the same URL.

A new movement referred to as “Viral” marketing is emerging. In such cases, digital content can be sent intact from person to person. As such, the content may arrive, un-“hosted” without its surrounding advertising messages. The Persistent Message Management invention is a means or method to embed and manage access to advertising and other messages integrated with widely dispersible digital content.

The invention includes a means to establish and embed unique URL addresses within content or bundled viewing software. The invention also describes a means of capturing a widely dispersed community of viewers. It also includes a method for altering messages which may be accessed by this wider Ad Hoc user community.

### BRIEF DESCRIPTION OF THE DRAWINGS

FIG. 1 is a diagram of an integrated digital data display system which includes a set of potential external data sources, a computer display device, display software and a connection through Internet to a Persistent Web-based Media Server;

FIG. 2 shows a set of four Digital Media Display states which are intended to demonstrate that by interacting with a media file, a user can access and activate hot-linked files which may be embedded in the media data file;

FIG. 3 is a flowchart of the integration of present invention which suggests two alternative sites for the hot-links—embedded within the media or embedded within the Digital Media Player;

FIG. 4 is a flowchart of the steps associated with a hot-linked activation and content delivery from the Persistent Web-based server to the client display device;

FIG. 5 is a schematic representation of the Persistent Web-based Media Server and its internal modules for Hot-link assignment, Hot-link response, and Content delivery;

FIG. 6 is a schematic representation of the Persistent Web-based Media Server and its Hot-link assignment, the Internet linkage to the Content Development system, and linkage to the Persistent Web-based Media Server Content Delivery module;

FIG. 7 is a schematic representation of the Persistent Web-based Media Server and its internal module for Content delivery to a network of users; and

FIG. 8 is a schematic representation of the Persistent Web-based Media Server and its internal module for User Response management.

### DESCRIPTION OF THE PREFERRED EMBODIMENT OF THE INVENTION

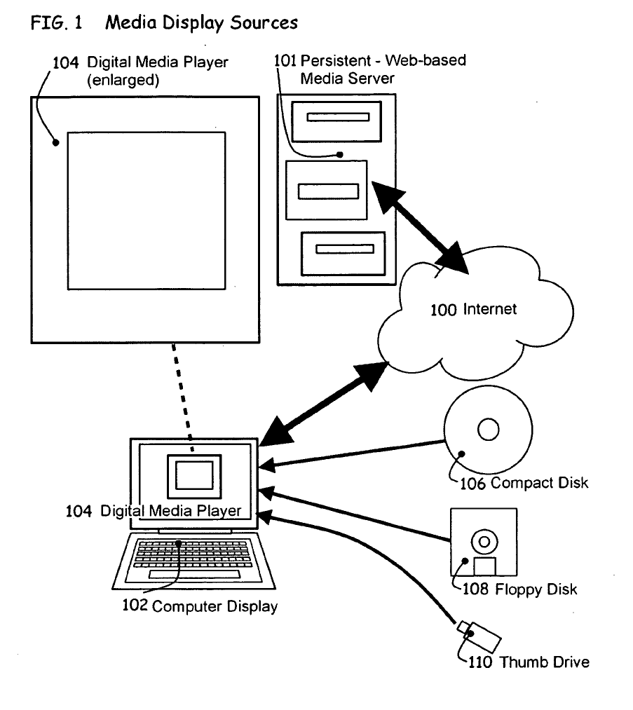

FIG. 1 is a diagram of an integrated computer system which includes a set of potential media sources including the Internet 100, a Compact Disk 106, a Floppy Disk 108, and a Thumb Drive 110. This set of data delivery mechanisms is used to simply convey the intent of this invention; it is expected that other delivery systems can be used or will be developed and to the extent these technologies can interact with hot-linked media, the application of this invention would hold. A user is connected through his or her Computer Display 102 to the Internet 100 for two distinct purposes, one purpose is to obtain and open an interactive media data file from an Internet site. In this case, the Internet 100 serves the same purpose as any other data delivery system such as a Floppy Disk 108, Thumb Drive 110 or Compact Disk 106. The second interaction with the Internet 100, would be to obtain access to the Persistent Web-based Media Server 101 on which advertising data or links to other relevant information can be accessed.

Fundamental to this invention is the fact that the embedded Hot-linked data is a unique hard coded absolute Uniform Resource Locator (URL) address for a file that is accessible through the Persistent Web-based Media Server 101. The Persistent Web-based Media Server 101 hosts advertising pages and links to additional information. This Persistent Web-based Media Server 101 is made accessible, when a user, interacting with Digital Media Player 104 or the Digital Media Player (enlarged) 104, activates embedded hard coded hot-links within the Digital Media or any attached Digital media Player.

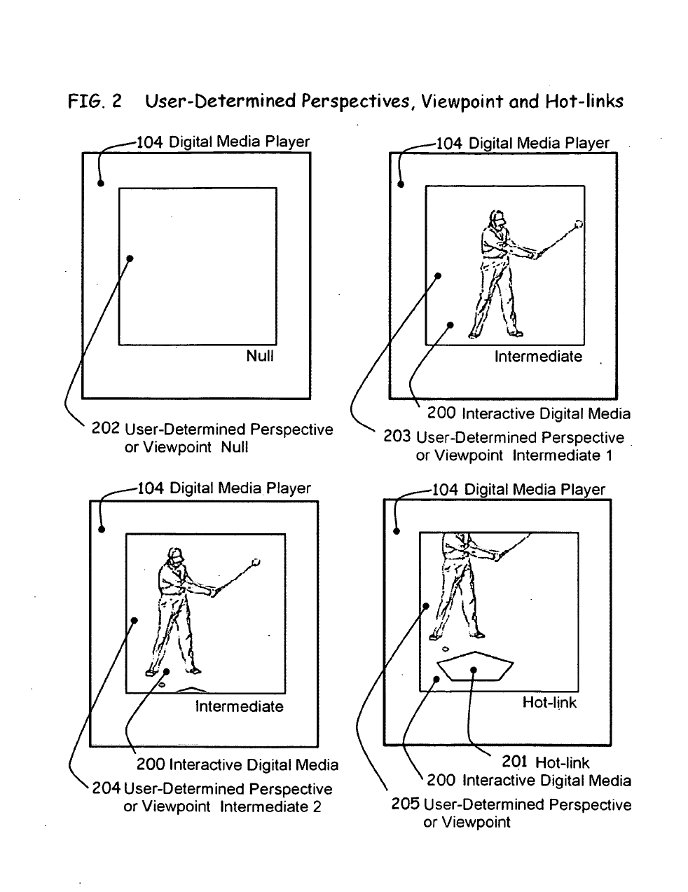

FIG. 2 is a diagram which shows 4 different states of the Digital Media Player 104. These states include—a “Null” state with no data being displayed and two “Intermediary” states in which digital content is being manipulated by the user. The manipulated states include User-Determined Perspective or Viewpoints 203, 204 and 205. A fourth “Hot-link” state shows digital media which reveals a Hot-link 201 region. This Hot-link region can be activated by the customer using the Digital Media Player 104.

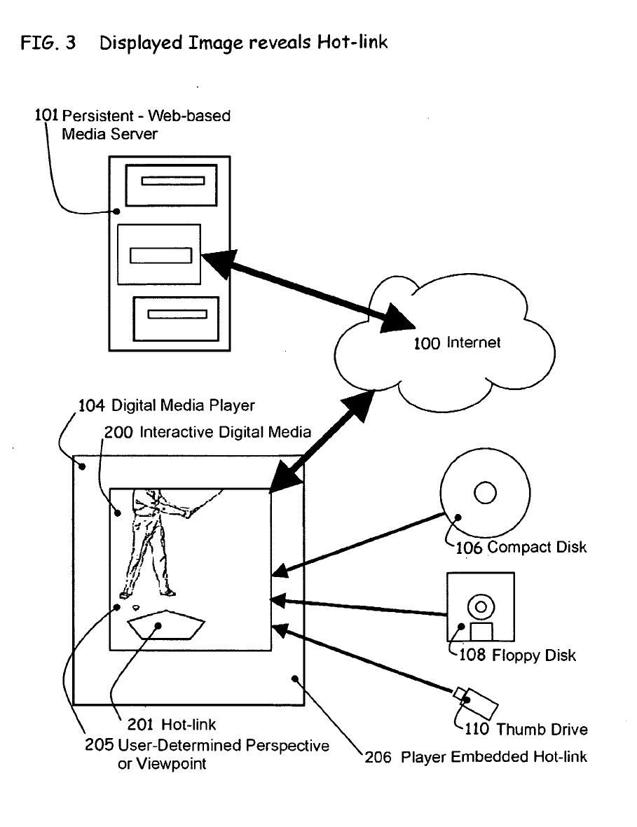

FIG. 3 is a diagram which shows a set of potential sources of Digital Media including the Internet 100, a Compact Disk 106, a Floppy Disk 108 and a Thumb Drive 110. The diagram also shows the Digital Media Player 104, Interactive Digital Media 200 which has been adjusted to the User-Determined Perspective or Viewpoint 2005 and an embedded Hot-link 201. The diagram also shows a two way link that is established via the Internet 100 between the Digital Media Player 104 and the Persistent Web-based Media Server 101. Through this link, a series of advertising or informational messages can be delivered from the Persistent Web-based Media Server 101 to the end user for display with the Digital Media Player 104.

The links to this content reside “hard coded” within the Interactive Digital Media 200. As an alternative, Hot-links 206 can be embedded in the Digital Media Player 104 that is bound to and distributed directly with the Interactive Digital Media 200. Regardless of the means by which that data is distributed, those links can actively access the URL addresses hosted on the Persistent Web-based Media Server 101. By retaining control of the Persistent Web-based Media Server 101, an advertising or information manager can alter the embedded message at will.

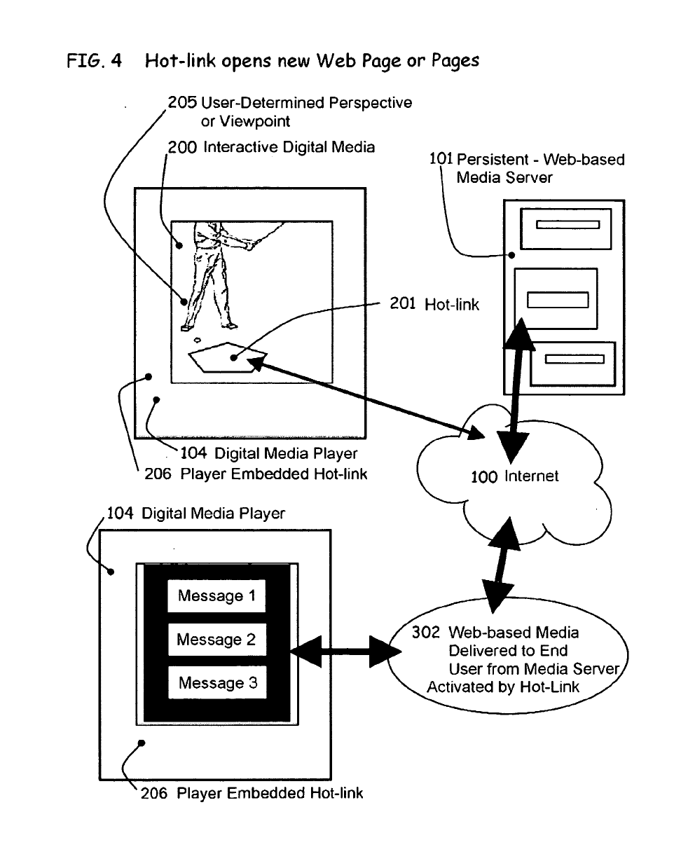

FIG. 4 Suggests how the Persistent Web-based Media Server 101 can deliver a targeted message to a user which can be accessed through the Digital Media Player 104 by the act of the viewer engaging an Hot-link 201 embedded in the Interactive Digital Media 200, or embedded in the attached Digital Media Player 104.

However, because the embedded Hot-links 201 or 206 refer to addresses on a Persistent Web-based Media Server, an advertising or information manager can remain in control of an embedded message no matter how that message was distributed. The Persistent Web-based Media Server can alter the perceived messages at will and the digital content can be transmitted intact to any user with access to the Internet who has initiated such action by engaging an embedded Hot-link.

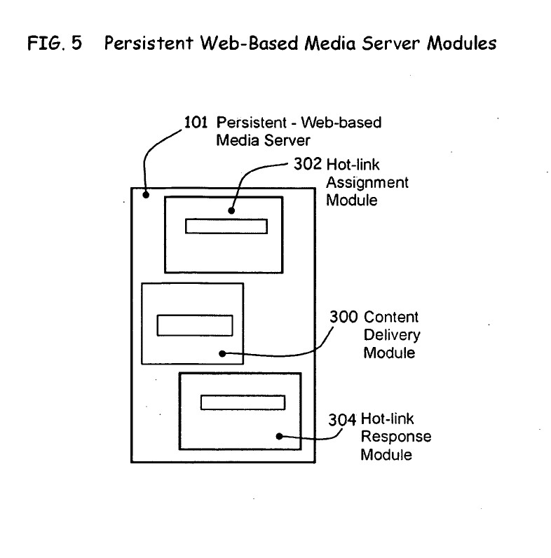

FIG. 5. Suggests how the Persistent Web-based Media Server 101 can include multiple internal modules including a Content Delivery Module 300, a Hot-link Assignment Module 302, and a Hot-link Response Module 304. In the preferred implementation of the Persistent Web-based Media Server 101, the Delivery Module 300 activated by the client side hot-link, can manage the delivery of content stored at a specific URL. The Hot-link Assignment Module 302 can create, log and assign discreet and unique identifiers to individual pieces of content or to individual bundled sets of content and content players which are subsequently made available to the community of users.

Key to this strategy is embedding fixed Internet addresses within the published digital content. These addresses are encrypted in a manner which makes their removal difficult. Rather than being tied internally to the distributed content, these are absolute addresses to sites hosted on the Persistent Web-based Media Server. The Hot-links remain “Persistent” and can be activated through the digital media display players.

The Hot-link Response Module 304 can aggregate responses from a community of client users and deliver aggregated or modified data back to the client devices through the Content Delivery Module 300. Such community based data could include community ratings, vote tallies, clues to on-line games or community based assembly of additional information which the community might bring forth. For example, an initial post might be a video clip taken from a surveillance camera showing a robbery. That clip could be virally distributed to a network of citizens who may add additional data, photos or cell phone video creating a more robust network of clues which might help resolve a dynamic situation quickly.

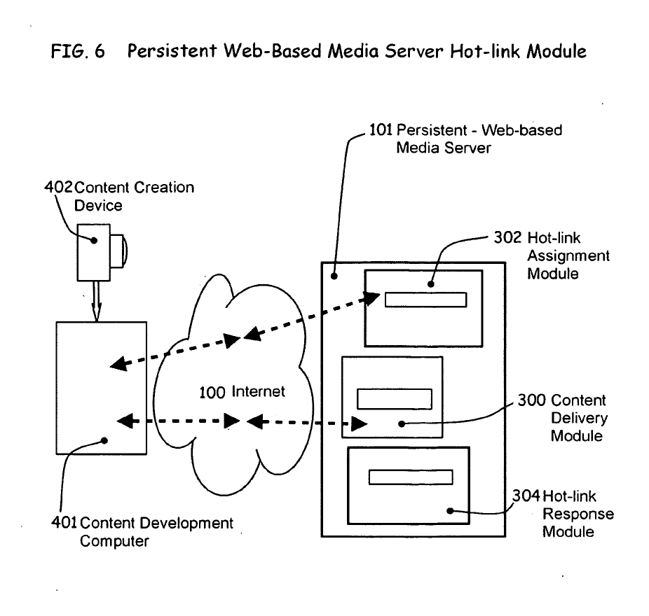

FIG. 6. Suggests how the Persistent Web-based Media Server 101 can interact with a Content Development Computer 401 and Content Creation Device 402 to assign unique Hot-link identification codes which would be embedded with media or with a bundled media player. The Hot-link Assignment Module 302 could communicate via the Internet 100 to produce unique Hot-link codes which would be used within the Content Development Computer 401 and forwarded to the Persistent Web-based Media Server 101 to the Content Delivery Module 300.

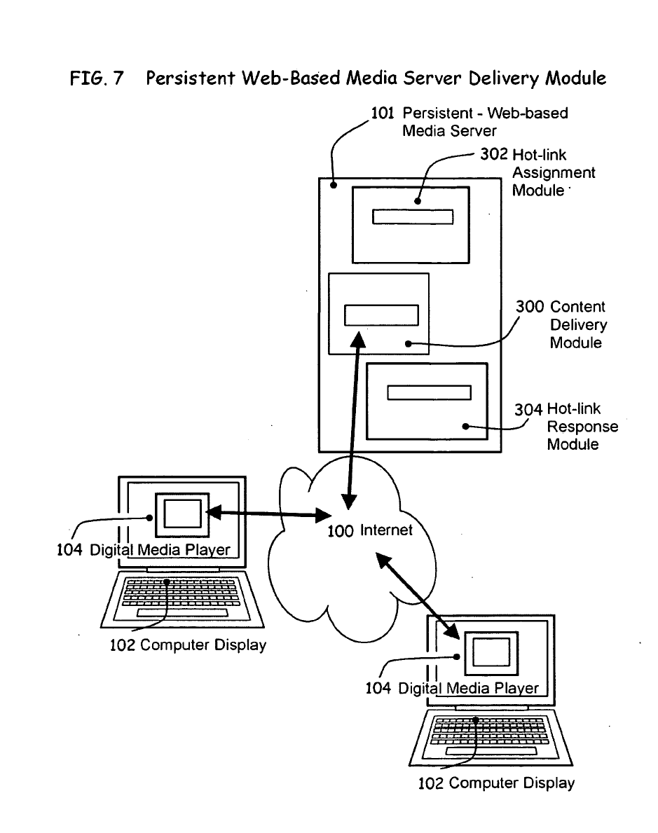

FIG. 7. Suggests how the Persistent Web-based Media Server 101 can use Internet 100 and its internal Content Delivery Module 300 to deliver Hot-linked response content to a community of Computer Display 102 clients. These client computers may have received the media by formal distribution means, by interacting with search engines or they may have received content by purely Ad Hoc Viral distribution.

The fact that the Persistent Web Based Media Server creates unique Hot-link codes which are hard coded in the media or bundled directly with the paired media and media players, results in a persistent link between the server and the media. That link forms the addressable community of media, users and messages which can be managed by the Persistent Web-based Media Server.

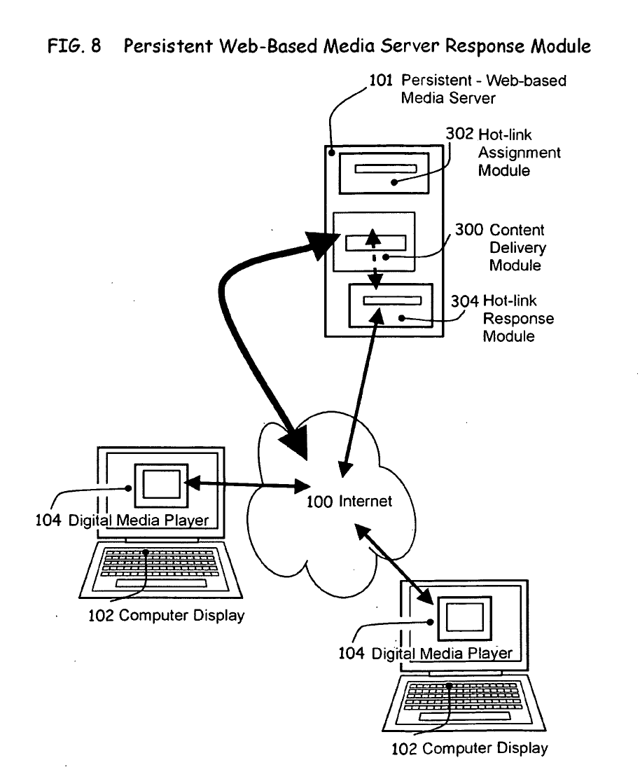

FIG. 8 Suggests how the Persistent Web-based Media Server 101 can use Internet 100 and its internal Content Delivery Module 300 to deliver Hot-linked response content to a community of Computer Display 102 clients. These client computers may interact with the Hot-link response module and alter content which is ultimately made available to the community if users.

Although the invention has been described in conjunction with providing commercial advertising to the user, the invention can also be applied to providing to the user any other type of information. The above-described embodiments are illustrative of the principles of the present invention. Other embodiments could be devised by those skilled in the art without departing from the spirit and scope of the present invention.

1. I claim a method of message management intended to be deployed as part of an Ad Hoc system in which users may extract digital media and re-distribute that content, yet which maintains control of related messages through the use of hard coded hot-links accessible by subsequent viewers, which, when activated by said users can display messages and web-pages which are managed, altered and controlled by a persistent message server.

2. I claim a method of message management intended to be deployed as part of an Ad Hoc system in which users may extract digital media and re-distribute that content, yet which maintains control of related messages through the use of hard coded hot-links embedded within the extracted media, but which remain accessible by subsequent viewers, and which, when activated by said users can display messages and web-pages which are managed, altered and controlled by a persistent message server.

3. I claim a method of message management intended to be deployed as part of an Ad Hoc system in which users may extract digital media and re-distribute that content, yet which maintains control of related messages through the use of hard coded hot-links embedded within an embedded viewer that is bundled with extracted media, but which remain accessible by subsequent viewers, and which, when activated by said users can display messages and web-pages which are managed, altered and controlled by a persistent message server.

4. I claim a method of message management intended to be deployed as part of an Ad Hoc system in which users may extract digital media and re-distribute that content, yet which maintains control of related messages through the use of hard coded hot-links accessible by subsequent viewers, which, when activated by said users can display messages and web-pages which are managed, altered and controlled by a persistent message server which tracks and assigns unique hot-link addresses which, through interaction with a content development computer are embedded directly in digital content.

5. I claim a method of message management intended to be deployed as part of an Ad Hoc system in which users may extract digital media and re-distribute that content, yet which maintains control of related messages through the use of hard coded hot-links accessible by subsequent viewers, which, when activated by said users can display messages and web-pages which are managed, altered and controlled by a persistent message server which tracks and assigns unique hot-link addresses which, through interaction with a content development computer are embedded directly in a distributed media viewer bundled with extracted digital content.

6. I claim a method of message management intended to be deployed as part of an Ad Hoc system in which users may extract digital media and re-distribute that content, yet which maintains control of related messages through the use of hard coded hot-links accessible by subsequent viewers, which, when activated by said users can display messages and web-pages which are managed, altered and controlled by a persistent message server which can track feedback in response to appropriate media and alter content which the persistent message server subsequently makes available for distribution from the Content Delivery module.

7. I claim a method of message management intended to be deployed as part of an Ad Hoc system in which users may extract digital media and re-distribute that content, yet which maintains control of related messages through the use of hard coded hot-links accessible by subsequent viewers, which, when activated by said users can display messages and web-pages which are managed, altered and controlled by a persistent message server which can receive user comments tied to specific content activated by any specific user and can use that data to establish a larger scale user community of known and defined users.
